(19) United States
(12) Patent Application Publication
(10) Pub. No.: US 2016/0379303 A1
(43) Pub. Date: Dec. 29, 2016

(54) SYSTEM AND METHOD FOR CREDIT EVALUATION

(71) Applicant: Retail Capital, LLC, Troy, MI (US)

(72) Inventor: Tina Chan Reich, New York, NY (US)

(73) Assignee: RETAIL CAPITAL, LLC, Troy, MI (US)

(21) Appl. No.: 14/747,086

(22) Filed: Jun. 23, 2015

(51) Int. Cl. G06Q 40/02

(52) U.S. Cl. CPC G06Q 40/025

(57) ABSTRACT

The present invention relates to a system and method for credit evaluation, and in particular for utilizing information from multiple information sources and/or related to multiple entities. In certain embodiments, a neural network is utilized to select among information to form a composite credit report involving entries from multiple information sources and/or related to multiple entities. In certain embodiments, where multiple information sources contain inconsistent information, a selection is made to determine which information is placed in a composite report. Alternatively or in conjunction, information may be weighted according to useful factors. In instances in which information related to multiple entities is evaluated, a selection may be made as to which information is included in a composite credit report.

### FIELD OF THE INVENTION

The present invention relates to a system and method for credit evaluation, and in particular for utilizing information from multiple information sources and/or related to multiple entities.

### BACKGROUND OF THE INVENTION

The use of credit scores or other forms of credit evaluation is common in today's economy. Access to credit is an important component of many businesses and individual's economic well being and advancement. Potential lenders and other entities often use quantification of consumer and business credit histories, typically in the form of credit scores, to make efficient, objective decisions about whether to extend credit and on what terms. Credit scoring is a tool for evaluating access to many goods and services such as credit cards, consumer loans, business loans and mortgages; as well as for many other types of financial transactions.

Credit scoring replaced burdensome manual credit reviews with neutral, statistics-based mechanisms for evaluation. A credit score is the result of analytical models that utilize a consumer's or business's credit report or other credit-related information, and translate it into a numerical value representing the amount of risk the consumer or business brings to a transaction. As a result of credit scoring, lenders can make faster, more objective decisions.

Three primary national credit reporting bureaus maintain credit information for most credit-active adults in the United States: Equifax, Experian and TransUnion. In addition, numerous other smaller bureaus and other consumer reporting agencies (“CRAs”) maintain credit information and other information for various segments of the economy. These include, by way of example: smaller credit reporting agencies (relative to the three national bureaus); employment or tenant screening agencies; automobile and property insurance agencies; low income credit reporting agencies; medical, retail and gaming agencies. Certain such entities may be registered under the Fair Credit Reporting Act; others may not.

Credit reporting agencies may compile consumer and business histories into credit reports, and credit scores are calculated by applying statistical weighting models to the information contained within the consumer's or business's credit report at the time a credit score is requested by a potential creditor. A potential lender, creditor, indemnitor, guarantor, seller, purchaser or the like (essentially, anyone who desires information regarding the credit or credit-worthiness of any other party, herein generally referred to as a “creditor” for convenience even where no actual lending or grant of credit is involved) can then utilize the credit score in deciding whether to approve or deny a request for credit.

It is also understood that the term “credit” herein is utilized broadly and globally for convenience. For example, it may include a loan, mortgage, credit card agreement, utility or similar account (gas, electric and the like), lease agreement, indemnity, guarantee or the like. As used herein, the term “credit” essentially includes any form of transaction or exchange that leads a “creditor,” as broadly defined above, to seek credit information regarding any party. The term “credit” further may include a purchase or interest in future receivables, such as a merchant cash advance. In such arrangements, a creditor may purchase future receivables of an entity such as a small business. The receivables may be returned to the creditor in a lump sum or over time, for example through a percentage of daily (or other periodic) credit card receipts, or a daily (or other periodic) ACH transfer or similar cash transfer. While such transactions may not typically be referred to as credit transactions because they are more akin to sales, it is understood that the term “credit” as used herein includes such transactions (and other transactions or exchanges as described above) for convenience.

In some instances, a credit score from one credit reporting agency will provide insufficient information for a potential creditor to make a decision to approve or deny credit. For example, the credit score may result in a “close call” on whether to approve or deny credit. Where a score from a single reporting agency is insufficient, the potential creditor can seek information from a second reporting agency or multiple additional reporting agencies. Typically, the credit scores from two or more reporting agencies are averaged, and the average may then be used in determining whether to approve or deny credit.

This averaging method has several shortcomings. First, certain reporting agencies may have consistently more accurate historical information regarding certain credit applicants compared to other reporting agencies. For example, disparities in information may arise depending on the type of underlying event being reported (e.g., automobile loan versus utility account), from geographic differences (e.g., a certain reporting agency may tend to have more information and more accurate information regarding consumers and businesses in a certain geographic area) or any other distinction. Second, different credit reporting agencies may have different information regarding a given previous event or transaction for an applicant. Averaging overall credit scores ignores these disparities in information, and makes no attempt to resolve inconsistencies in the underlying information, even for the same historical events. Moreover, averaging “thins” the data, making it less robust rather than more robust.

### SUMMARY OF THE INVENTION

The present invention overcomes the above and other shortcomings of current credit evaluation and scoring. It can be summarized in the following exemplary aspects.

In a first exemplary aspect, a method of evaluating credit comprises receiving a first credit report regarding an entity from a first reporting agency, the first credit report containing at least one first entry; receiving a second credit report regarding the entity from a second reporting agency, the second credit report containing at least one second entry; determining whether a selected first entry and a selected second entry relate to a same event; determining, when the selected first entry and the selected second entry relate to the same event, whether the selected first entry and the selected second entry reflect inconsistent information regarding the same event; and creating a composite credit report containing at least one of the selected first entry and the selected second entry.

In a second exemplary aspect, a method of evaluating credit comprises receiving a first credit report regarding an entity from a first reporting agency, the first credit report containing at least one first entry; receiving a second credit report regarding the entity from a second reporting agency, the second credit report containing at least one second entry; determining whether a selected first entry and a selected second entry are common entries; determining whether the selected first entry and selected second entry reflect inconsistent information; and if the selected first entry and the selected second entry are common entries that reflect inconsistent information, creating a composite credit report that includes at least one of the selected first entry and the selected second entry.

In a third exemplary aspect, a method of evaluating credit comprises receiving a primary credit report regarding a primary entity, the primary credit report containing at least one primary entry; receiving an ancillary credit report regarding an ancillary entity, the ancillary credit report containing at least one ancillary entry; and creating a composite credit report that includes at least one of the primary entries and at least one of the ancillary entries.

In a fourth exemplary aspect, a method of evaluating credit comprises receiving a first credit report regarding a primary entity, the first credit report containing at least one first primary entry; receiving a second credit report regarding the primary entity, the second credit report containing at least one second primary entry; receiving an ancillary credit report regarding an ancillary entity, the ancillary credit report containing at least one ancillary entry; and creating a composite credit report that includes at least one of the first primary entries and the second primary entries, and at least one of the ancillary entries.

### BRIEF DESCRIPTION OF THE DRAWINGS

FIG. 1 is a schematic view of an exemplary credit report for an entity.

FIG. 2 is a schematic view of another exemplary credit report for the entity of FIG. 1.

FIG. 3 is a schematic view of another exemplary credit report for the entity of FIG. 1.

FIG. 4 is a schematic view of exemplary data related to an exemplary composite credit report according to the present invention.

FIG. 5 is a schematic view of an exemplary composite credit report according to the present invention.

FIG. 6 is a schematic view of another exemplary credit report according to the present invention.

FIG. 7 is a schematic view of exemplary data related to credit reports for multiple exemplary entities.

FIG. 7A is a schematic view of exemplary credit reports for the entities of FIG. 7.

FIG. 8 is a schematic view of further exemplary composite credit reports according to the present invention.

FIG. 9 is a schematic diagram of an exemplary computer system for use with the present invention.

FIG. 10 is a flow diagram of an exemplary method according to the present invention.

FIG. 11 is a flow diagram of another exemplary method according to the present invention.

FIG. 12 is a flow diagram of another exemplary method according to the present invention.

FIG. 13 is a flow diagram of another exemplary method according to the present invention.

FIG. 14 is a flow diagram of another exemplary method according to the present invention.

FIG. 15 is a flow diagram of another exemplary method according to the present invention.

### DETAILED DESCRIPTION OF EXEMPLARY EMBODIMENTS

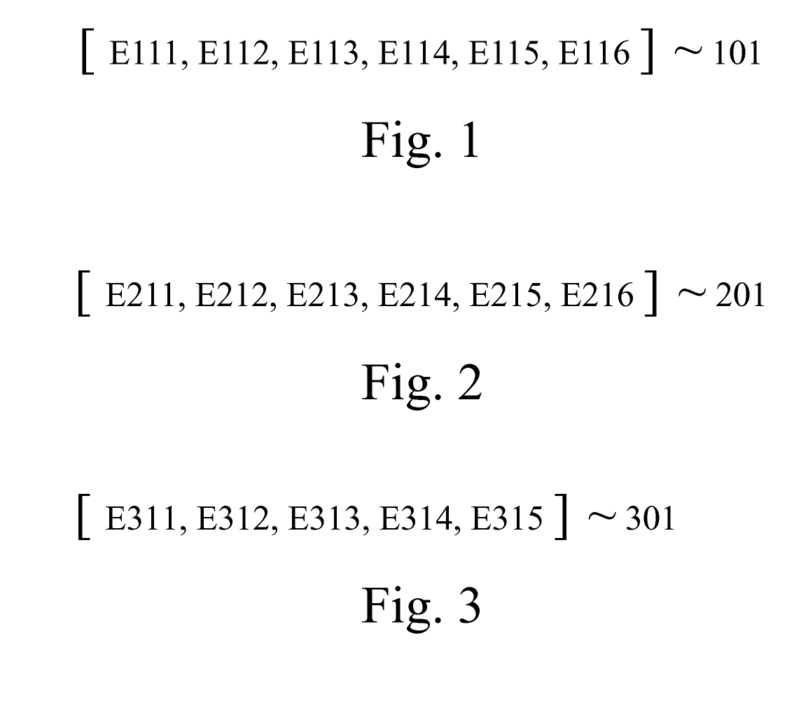

The present invention utilizes credit reports, scores and their underlying data in a manner that provides more accurate information to potential creditors. FIGS. 1, 2 and 3 schematically shows credit reports 101, 201 and 301 from three credit reporting agencies regarding a potential credit transaction. It is understood that the term “credit reporting agency” herein refers to any entity that provides credit or credit-related information to other entities. It is understood that credit or credit-related information can relate to any information that may be used to evaluate a credit decision, all of which may collectively be referred to herein as “credit information” for convenience. Examples of credit reporting agencies include, but are not limited to: Equifax, Experian, TransUnion, as well as examples of the many types credit reporting agencies set forth above such as regional or specialized agencies.

It is also understood that the term “credit report” as used herein is construed broadly, to not require any specific information or format. The term “credit report” as used herein applies to information or any collection of credit information regardless of whether it relates to an individual (i.e., a natural person), or a business, or any other organization (all of which are collectively referred to herein as “entities”). The term “credit report” is understood to include any information that may be visually presented to a purchaser of the report, as well as information, data, etc. that underlie or form a basis for any visually-presented information.

It should be noted that the term “credit report” can include information already maintained by or in possession of a potential creditor, so that such information can be incorporated into a composite credit report below. Certain such information may be proprietary, for example. As one example, a potential creditor may have information regarding prior lending arrangements with a potential credit recipient. As another example, an ongoing transaction such as a merchant cash advance can provide information such as daily revenue, frequency of remittance, etc. Such information, whether public or proprietary, may assist with decisions about which information to include within a composite credit report as described herein, or may be included within a composite credit report as described herein. Accordingly, it is understood that such information may be included within the term “credit report” as utilized herein. As further used here, a “credit report” may include any information or collection of information about past and present loans, transactions, credit lines, accounts, employment, housing, etc. Each such item is referred to herein as an “event,” and an event may be represented by an “entry” in the credit report. That is, the term “event” as used herein refers to an actual loan, transaction, credit line, account, employment, domicile, or the like; and the term “entry” refers to the data within or underlying the credit report reflecting an “event.”

In FIGS. 1, 2 and 3, exemplary credit reports 101, 201 and 301 are represented schematically, and entries within each report have been numerically identified for clarity and convenience. For example, credit report 101 comprises entries E111, E112, E113, E114, E115 and E116. It is understood that these numerical designations are utilized only for clarity of description. They are not intended as limiting, or as dictating any particular order or format of the information within the credit report. Likewise, exemplary credit report 201 comprises entries E211, E212, E213, E214, E215 and E216. Exemplary credit report 301 comprises entries E311, E312, E313, E314, and E315 (deliberately one entry less than credit reports 101 and 201, for exemplary description below). In the example of FIGS. 1, 2 and 3, each of credit reports 101, 201 and 301 are from separate credit reporting agencies, but all relate to the same entity.

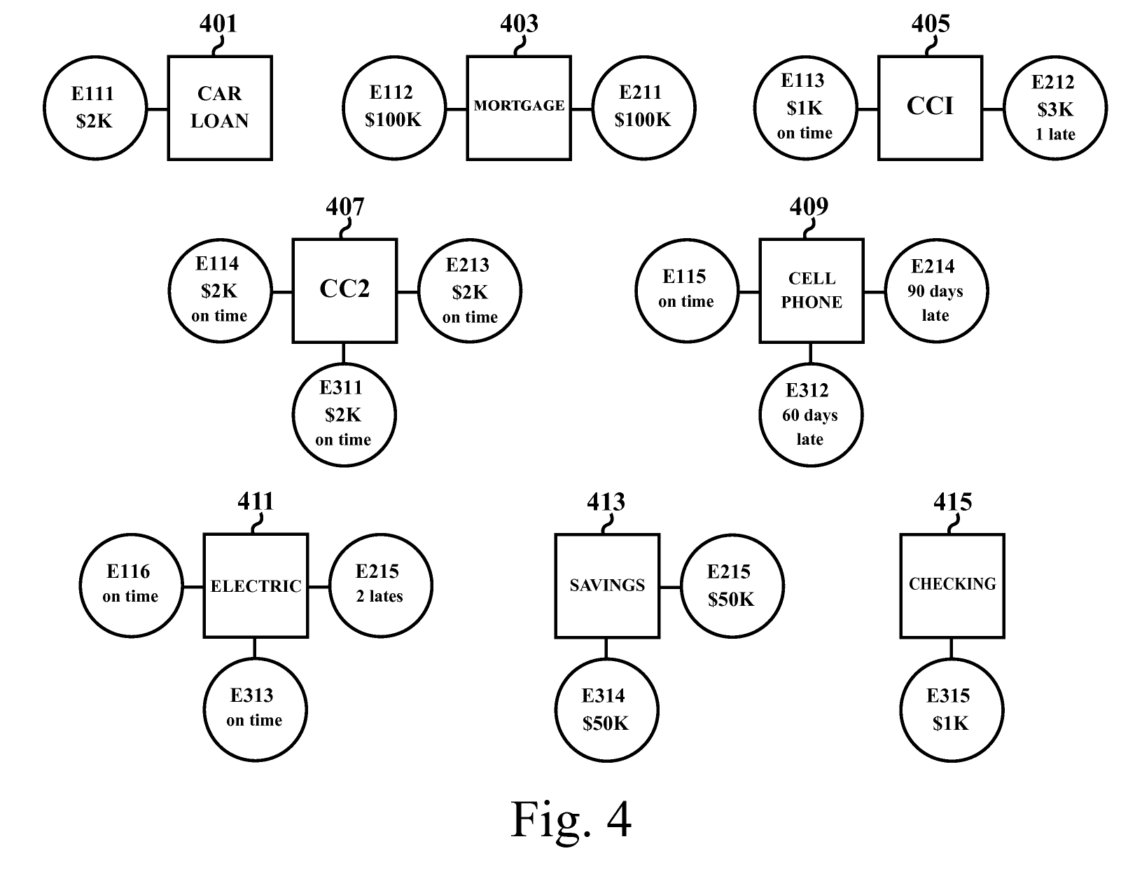

FIG. 4 is a schematic representation of the relationship between the exemplary entries of credit reports 101, 201 and 301, and the exemplary events to which the individual entries relate. In FIG. 4, exemplary events are outlined in rectangular fields, while the entries related to each event are outlined in circular fields. As can be seen, each entry in FIGS. 1 to 3 is represented on FIG. 4, associated with a particular event.

Multiple entries from separate credit reports that relate to a single event are referred to herein as “common entries.” The term “common entry” is utilized herein for clarity and convenience, and should not be construed as a limitation on the invention. As can be seen in FIG. 4, entry E111 of credit report 101 relates to event 401, a car loan. Entry E111 is not a common entry with any entry of credit report 201 or credit report 301.

In the example of FIG. 4, entries E112 (of credit report 101) and E211 (of credit report 201) are common entries for event 403, a mortgage. As further seen with respect to event 403, common entries E112 and E211 reflect “consistent” information regarding event 403. As used herein, the term “consistent” information refers to information that is materially the same in substance with respect to the underlying event; regardless of formatting, order of appearance within a credit report, etc. In the particular example of event 403, both entries E112 and E211 reflect a remaining principal of $100k on the mortgage.

As further shown in the example of FIG. 4, entries E113 (of credit report 101) and E212 (of credit report 201) are common entries for event 405, a credit card account designated as CC1. As further seen with respect to event 405, common entries E113 and E212 reflect “inconsistent” information regarding event 405. As used herein, the term “inconsistent” information refers to information that is materially different in substance with respect to the underlying event. In the particular example of event 405, both entry E113 (of credit report 101) reflects a $1k balance, with no late payments in the last twelve months. In contrast, entry E212 reflects a $3k balance, with one late payment in the last twelve months.

Event 407 of FIG. 4 represents a second exemplary credit card account designated CC2. Three entries—entry E114 (of credit report 101), entry E213 (of credit report 201), and entry E311 (of credit report 301)—are common entries with respect to event 407. As shown, they reflect consistent information with respect to event 407.

Event 409 of FIG. 4 represents an exemplary cell phone account. Three entries—entry E115 (of credit report 101), entry E214 (of credit report 201), and entry E312 (of credit report 301)—are common entries with respect to event 409. As shown, they reflect completely inconsistent information with respect to event 409. That is, no two entries reflect materially the same information with respect to event 409.

Event 411 of FIG. 4 represents an exemplary electric service account. Three entries—entry E116 (of credit report 101), entry E215 (of credit report 201), and entry E313 (of credit report 301)—are common entries with respect to event 4011. As shown, they reflect partially inconsistent information with respect to event 411. That is, entries E116 and E313 reflect consistent information with respect to event 409, and each reflects inconsistent information with respect to entry E215.

Event 413 of FIG. 4 represents an exemplary savings account. Entries E215 (of credit report 201) and E314 (of credit report 301) are common entries for event 413, a savings account. As shown, the entries reflect consistent information.

Event 415 of FIG. 4 represents an exemplary checking account. Among the three exemplary credit reports of FIGS. 1, 2 and 3, only credit report 301 includes an entry related to this account, entry E315. There is no common entry with entry E315.

The various exemplary credit reports, events and entries set forth in FIGS. 1 through 4 provide a number of exemplary permutations for demonstrating the present invention.

The present invention involves “composite” credit reports. A composite credit report according to the invention may be created where a single pre-existing credit report is insufficient for any reason, and/or where additional information is desirable. As one example, a pre-existing credit report or credit score may present a “close call” regarding a decision to grant or deny credit. In such cases, additional credit information may be desirable. The present invention provides a system and method for deriving such information.

In particular, according to the invention, a composite credit report and/or score is not created solely by averaging credit scores for two or more credit reports. Instead, a composite credit report according to the invention is created, at least in part, by identifying entries in two or more pre-existing credit reports that relate to common events, but nevertheless include inconsistent information, and then selecting between the individual entries or weighting the individual entries to create a composite credit report. Some or all non-common entries within the pre-existing credit reports may also be included, as well as some or all of any common entries in the pre-existing credit reports that reflect consistent information. If desired, a credit score can be derived from the composite credit report.

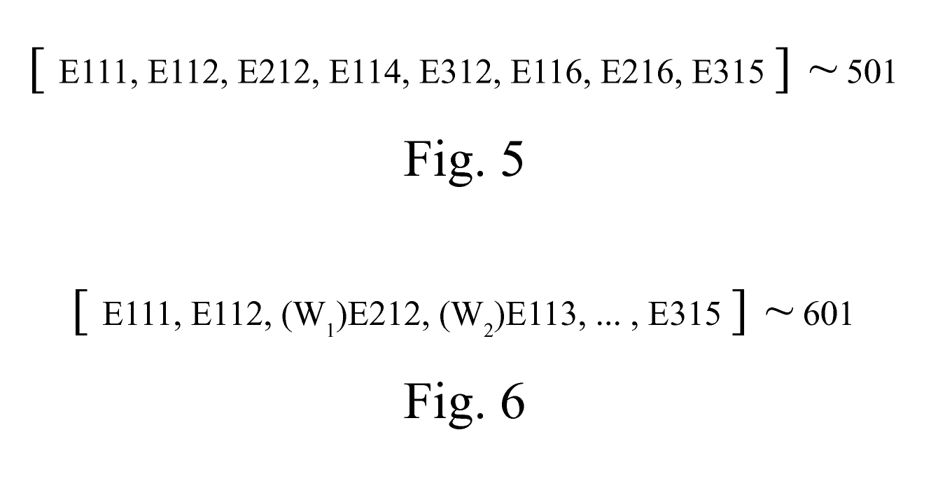

FIG. 5 shows an exemplary composite credit report 501 according the present invention. As with the credit reports 101, 201 and 301, composite credit report 501 is represented purely schematically. In the example of FIG. 5, composite credit report 501 was derived using pre-existing credit reports 101 and 201 of FIGS. 1 and 2, respectively. It can be understood from the Figures and the description below how each entry in composite credit report 501 was derived.

For example, composite credit report 501 includes any entry that is unique to either credit report 101 or credit report 201. Accordingly, composite credit report 501 includes entry E111, which as shown in FIG. 4 is the only entry related to event 401. Likewise, composite credit report 501 includes entry E315, which is the only entry related to event 415. A composite credit report according to the present invention may include all such unique entries, or a subset, or none. It is understood that the term “include” with respect to entries is construed broadly, and the present invention is not limited by the manner or mechanics in which entries are collected or compiled into a composite credit report.

Composite credit report 501 also includes, for example, any common entry reflecting consistent data for the relevant entries. As specific examples, entry E112, entry E114, and entry E215 each appear in composite credit report 501. Specifically, entry E112 is common with entry E211 (both related to event 403), and the two entries reflect consistent information regarding event 403. Accordingly, in this exemplary embodiment, either E112 or E211 could have been included in composite credit report 501. For convenience, entry E112 was included with composite credit report 501. It is understood that with respect to such common entries reflecting consistent information, any relevant entry may be included within a composite credit report according to the present invention. For example, with respect to event 403, either event E112 or event E211 could have been included without material difference, since by assumption (in this example), those events reflect consistent information. The selection of one versus the other for inclusion in exemplary composite credit report 501 is purely by way of example, and is not construed as a limitation on the invention.

As further examples, as shown in FIG. 4, entry E114 is common with entries E213 and E311 (all related to event 407), and all three entries reflect consistent information regarding event 407. Accordingly, one of the entries, specifically entry E114 by way of example, is included in composite credit report 501. Likewise, entry E216 is common with entry E314 (both related to event 413), and the two entries reflect consistent information regarding event 413. Accordingly, one of the entries, specifically entry E216 by way of example, is included in composite credit report 501.

A system and method according to the invention may utilize any known sorting and/or comparison technologies or methodologies for identifying common entries. Such processes and technologies are well known, for example in database related applications, and any useful process and/or technology may be utilized to identify common entries between two or more credit reports. In the same manner, a system and method according to the invention may utilize any known technology for determining whether a given set of common entries reflect consistent or inconsistent data. Such processes and technologies are well known, and any useful process and/or technology may be utilized.

In an exemplary embodiment, a composite credit report according to the present invention may also include one or more entries selected from one or more groups of common entries reflecting inconsistent data. In the example of FIG. 5, composite credit report 501 includes three such entries: E212, E312 and E116. Specifically, as discussed further below, E212 is selected for inclusion with respect to event 405; E312 is selected for inclusion with respect to event 409, and E216 is selected for inclusion with respect to event 413.

With respect to entry E212 and event 405, it can be seen from FIG. 4 that event 405 has two related entries: E113 and E212. In other words, credit report 101 and credit report 201 both include entries with respect to event 405. As further shown in FIG. 4, the entries related to event 405 reflect inconsistent information about the event. E113 shows a balance of $1k, and no late payments in the previous twelve months, E212 shows a balance of $3k, and one late payment within the last twelve months. In the exemplary embodiment of FIG. 5, one of the entries, specifically entry E212 by way of example, is selected for inclusion in composite credit report 501. (Mechanisms for selection of one entry among multiple entries reflecting inconsistent information are discussed below.)

Similarly, event 409 has three related entries: E115, E214 and E312. In other words, each of example credit reports 101, 201 and 301 includes an entry with respect to event 409. As further shown in FIG. 4, each of the entries related to event 409 reflects inconsistent information relative to the other two entries. In the exemplary embodiment of FIG. 5, one of the entries, specifically entry E312 by way of example, is selected for inclusion in composite credit report 501. (Mechanisms for the selection are discussed further below.)

Similarly, event 411 has three related entries: E116, E215 and E313. In other words, each of example credit reports 101, 201 and 301 includes an entry with respect to event 411. As further shown in FIG. 4, two of the entries related to event 409 reflects consistent information relative to each other (entries E116 and E313, showing no late payments in the previous twelve months), but both reflect inconsistent information with respect to the third entry (E215, showing two late payments in the previous twelve months). In the exemplary embodiment of FIG. 5, one of the entries, specifically entry E312 by way of example, is selected for inclusion in composite credit report 501. It is noted that in this example, inclusion of E312 is not materially different than inclusion of E116, since the two entries reflect consistent information. Again, mechanisms for selection of one entry among multiple entries reflecting inconsistent information are discussed below.

Generally, the selection between two or more common entries that reflect inconsistent information may be made based on any useful criteria. In a preferred embodiment, the criteria for selection between two common entries with inconsistent data is accuracy. In other words, the entry that most likely aligns with the real world event is selected. As a particular example, common entries from two respective credit reports may each relate to an outstanding loan. One entry might indicate the loan is paid off; the second entry might indicate that the loan is outstanding and past due. In making a decision regarding which entry to include in a composite credit report, a system according to the present invention may seek to select the entry that most likely represents the real status of the loan.

Generally, the selection between two or more common entries that reflect inconsistent information may be made with any useful process or mechanism. In a preferred embodiment, a neural network or other machine learning mechanism is utilized to make selections between two more such entries. As is understood, neural networks and other machine learning techniques may, for example, utilize a known dataset to derive one or more rules or rule sets that seek a given outcome. In general, a system according to the present invention may utilize any useful machine learning or neural network processing or mechanism to determine, when common entries of two or more credit reports reflect inconsistent information, which of the common entries will be included within a composite credit report.

In a preferred embodiment, a neural network is utilized to determine the selection between two or more common entries that contain inconsistent information, and/or to determine whether any entry (common or not, inconsistent or not) is included within a composite credit report. As utilized herein, the term neural network generally refers to a class of machine learning mechanisms in which the numerical parameters, i.e. the input data, are assigned adaptive weight by a learning algorithm and which is capable of approximating non-linear functions of the input data. A typically common feature across the various learning paradigms employed in neural networks is the principle of non-linear, distributed, parallel and local processing, and adaptation.

Typically, neural networks employ one of several major learning paradigms: for example supervised learning, unsupervised learning, and reinforcement learning. There are a number of neural network models that fall within the learning paradigms listed above. In general, any of these types may be utilized with these exemplary embodiments of the present invention as useful or desired. Likewise, any other type of neural network may be utilized as useful or desired.

In a supervised learning paradigm, the desired output for the neural network may be provided with the input, and an error is calculated between the desired output and the actual output. A weight assigned to each input variable is then updated to produce an actual output that better matches the desired output. Supervised learning neural network models include, for example, backpropagation, autoencoder, and cascading neural networks.

In an unsupervised learning paradigm, input data may be provided to the neural network, and it is the neural network's responsibility to detect any hidden structure in the otherwise unlabeled input data without the aid of a desired output. Since the input data provided to the neural network is unlabeled, there is no error or reward signal to evaluate the output of the neural network. Unsupervised learning neural network models include, for example, Kohonen self-organizing maps and radial basis function networks.

A reinforcement learning paradigm is similar to a supervised learning paradigm in that there is a desired output, however, instead of providing the desired output to the neural network or correcting sub-optimal outputs, the focus may be on finding a balance between exploration of unknown data and exploitation of known data, and incorporating the output result into subsequent operations. Reinforcement learning neural networks include, for example, Q-learning and Monte Carlo methods.

Any useful data may be utilized to train a neural network or other machine learning features according to the present invention. In a preferred embodiment, historical data from credit reporting agencies may be utilized to train a neural network regarding the likelihood that a given entry accurately reflects the related real world event. In particular, over time each credit reporting agency tends to correct any errant entries in a credit report as information is further developed or comes available. Over time, by analyzing adjustments to credit reports for one or more entities, and in particular for a large number of entities, a neural network can learn which reporting agencies tend to provide more accurate or reliable information based on relevant criteria such as geography, type of account, amounts, etc.

Another method for training a neural network or other machine learning process relates to decisions made by the system over time. For example, in each instance in which the system rendered a composite credit report and/or score that was more “positive” than otherwise feasible, and a decision is then made to grant credit, subsequent delinquencies or failures by the credit recipient to repay credit or otherwise “make good” on a transaction can provide feedback for the system. This analysis and data may be developed over time, or can be developed by, for example, purchasing a sample set of historical data from one or more credit reporting agencies.

Similarly, in each instance in which the system rendered a composite credit report and/or score that was more “negative” than otherwise feasible, and a decision is then made to deny credit, subsequent successes of the credit recipient to repay credit or otherwise “make good” on a transaction can provide feedback for the system. These subsequent successes may be captured through a purchase of data from a credit reporting agency, for example to evaluate the credit recipients payment or transaction history with other entities that did grant credit to the recipient.

Another preferred embodiment of a composite credit report according to the present invention is shown in FIG. 6. In particular, composite credit report 601 of FIG. 6 is derived from the exemplary events and entries of FIG. 5. Composite credit report 601 differs from composite credit report 501 of FIG. 5, however, in that where common entries are present that reflect inconsistent information, FIG. 6 includes each of the relevant entries in a weighted fashion. In other words, rather than including a single entry among the common entries, to the exclusion of others, composite credit report 601 includes two or more such entries among a group of common entries, with each entry receiving a probabilistic weight. In a preferred embodiment, the probabilistic weights add up to the value 1.

For brevity, composite credit report 601 illustrates a single instance of weighting, in the manner that differentiates composite credit report 601 from composite credit report 501. Specifically, as shown in FIG. 4, two common entries relate to event 405: E113 of credit report 101, and E212 of credit report 201. As also shown in FIG. 4, these common entries reflect inconsistent information regarding event 405. According to an exemplary embodiment of the present invention, each of the common entries E113 and E212 are included in a weighted fashion in composite credit report 601. Specifically, entries E212 is weighted by factor W₁, and entry E113 is weighted by factor W2. It is understood that the order in which entries E212 and E113 appear in composite credit report 601 is for illustration only, and should not be considered a limitation on the invention. It is also understood that other possible entries are omitted from exemplary composite credit score 601, as illustrated by ellipses in FIG. 6.

In further exemplary embodiment of the invention, a system according to the present invention may derive a composite credit report from credit reports related to multiple entities. In potential credit transactions related in which a business is a potential borrower, guarantor or the like, potential creditors may seek credit reporting information not only from the business, but from various other entities such as, but not limited to, owners, officers, directors and/or guarantors of the business. In such a case, averaging credit scores for each of the entities, for example, may provide insufficient information to make a decision to grant or deny credit.

A system according to the present invention may provide a composite credit report for multiple entities that provides more accurate or otherwise desirable information on which to make a credit decision. In particular, a system according to the present invention may select among various entries from credit reports of multiple entities, and create or derive a composite credit report that includes selected entries related to each entity. It is understood that “creating” or “deriving” any composite credit report as described herein should be construed broadly, to include any useful manner of collecting entries into a group. A composite credit report according to this aspect of the invention may include one or more selected entries from separate entities.

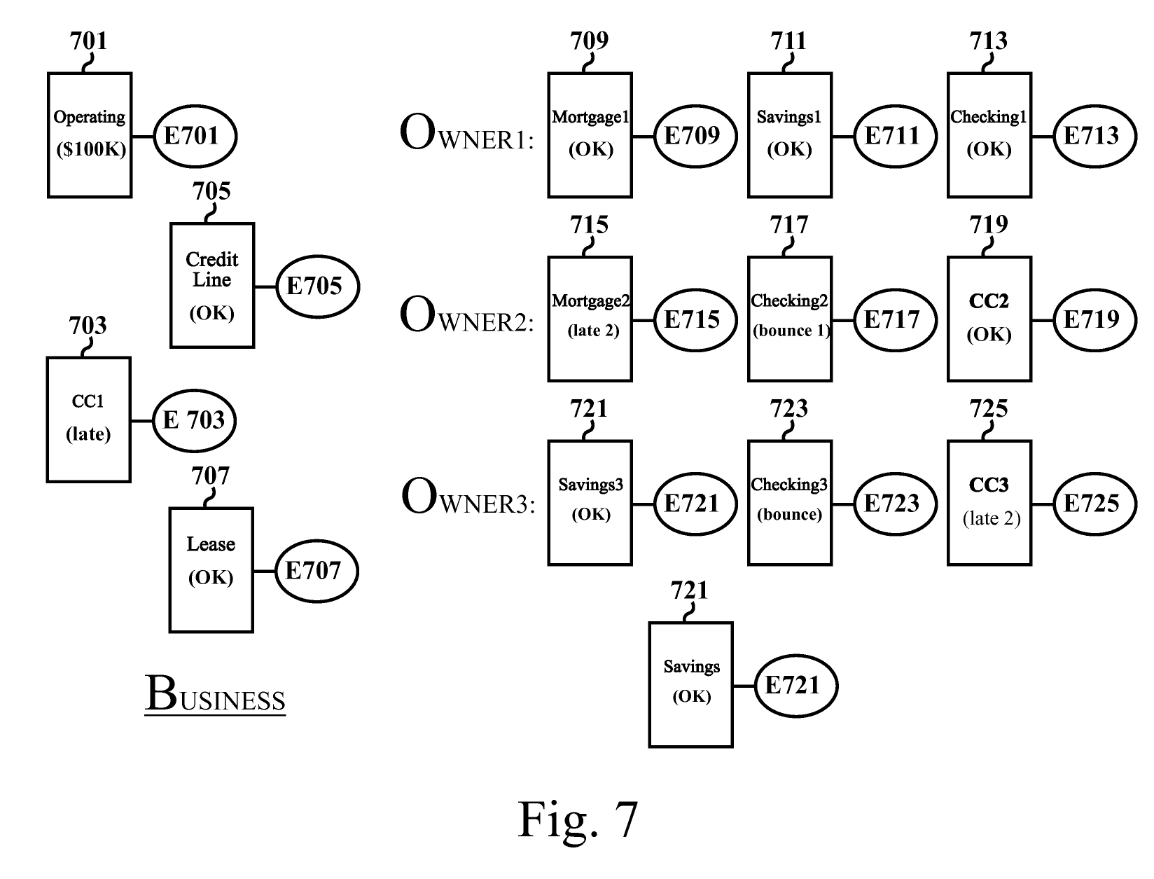

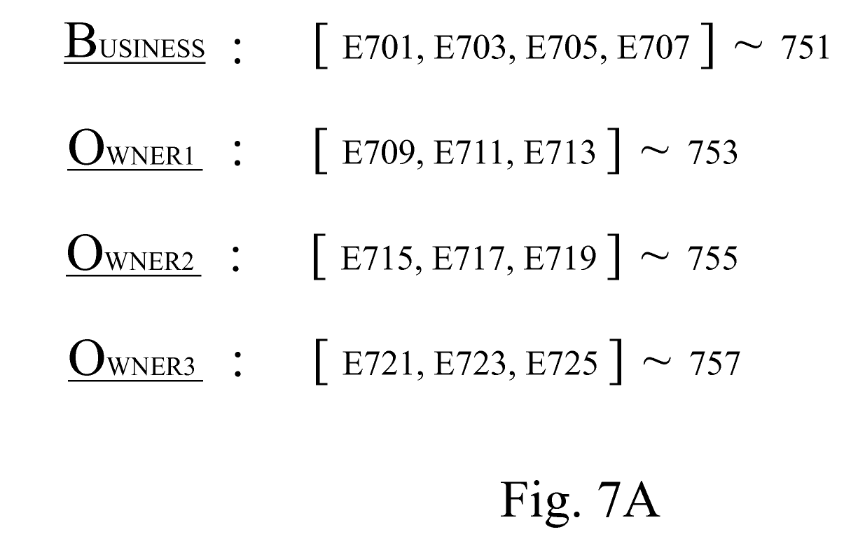

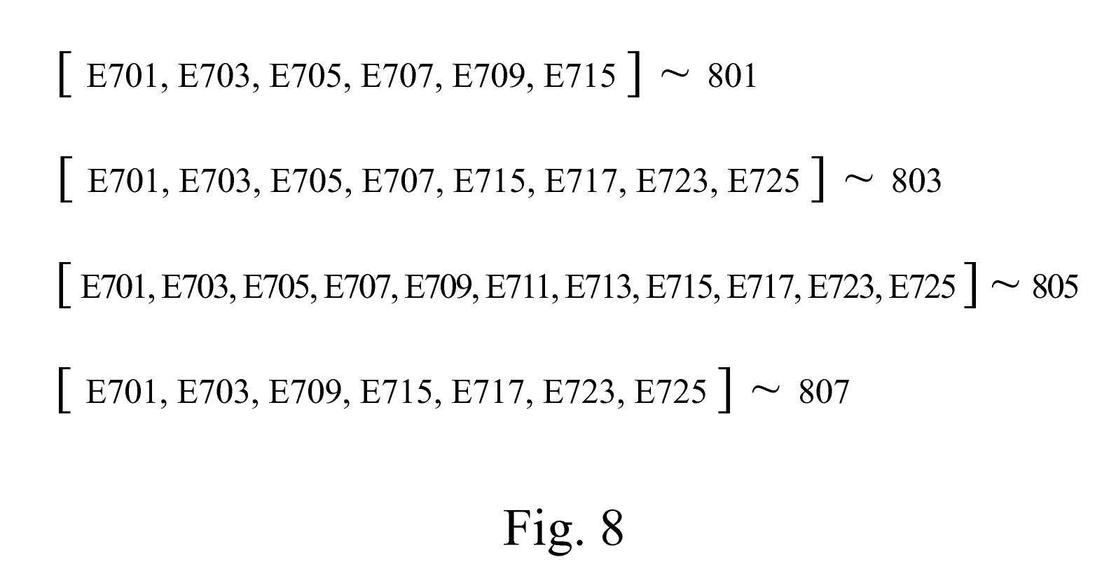

Non-limiting examples of this aspect of the invention are shown in FIGS. 7, 7A and 8. FIG. 7 shows an exemplary series of events with related entries for multiple entities. This example is understood to be simplified for clarity of description (e.g., having only a small number of events and entries for each entity). Exemplary events 701, 703, 705 and 707 related to an exemplary Business to which a credit decision is directed. For example, the business may seeking credit in the form of a line of credit, equipment loan, credit card, etc., and an potential creditor is evaluating whether to grant or deny credit. An entity to which a credit decision is directed may be referred to herein as a primary entity. It is understood that the term “primary” is used only for clarity of description, and does not constitute any limitation on the invention.

As shown in FIG. 7, event 701 is an operating account of the Business with a balance of $100k; event 703 is a credit card account with one late payment; event 705 is a credit line with no late payments; and event 707 is a lease with no late payments. Associated with the events are credit report entries E701, E703, E705 and E707, respectively. In the example of FIG. 7, it is assumed for brevity and clarity of description that the information in each entry accurately reflects the respective event.

As further shown in the example of FIG. 7, the exemplary Business has three owners. A potential creditor may wish to evaluate the credit of such owners in determining whether to grant or deny credit to the Business. An entity whose credit may be evaluated as part of a decision to grant to deny credit to another (“primary”) entity is referred to herein as an “ancillary” entity. It is understood that the term “ancillary” is used only for clarity of description, and does not constitute any limitation on the invention.

As shown in FIG. 7, exemplary events 709, 711 and 713 of FIG. 7 relate to Owner 1. Event 709 is a mortgage with no late payments; event 711 is a savings account with no history of credit issues; event 713 is a checking account with no history of credit issues. Associated with the events are credit report entries E709, E711, and E713, respectively. In the example of FIG. 7, it is assumed for brevity and clarity of description that the information in each entry accurately reflects the respective event.

Exemplary events 715, 717 and 719 of FIG. 7 relate to Owner 2. Event 715 is a mortgage with two late payments in the previous twelve months; event 717 is a checking account that has been overdrawn once in the previous twelve months; event 719 is a credit card account with no history of late payments. Associated with the events are credit report entries E715, E717, and E719, respectively. In the example of FIG. 7, it is assumed for brevity and clarity of description that the information in each entry accurately reflects the respective event.

Exemplary events 721, 723 and 725 of FIG. 7 relate to Owner 3. Event 721 is a savings account with no history of credit issues; event 723 is checking account that has been overdrawn once in the previous twelve months; event 725 is a credit card account with two late payments in the previous twelve months. Associated with the events are credit report entries E721, E723 and E725, respectively. In the example of FIG. 7, it is assumed for brevity and clarity of description that the information in each entry accurately reflects the respective event.

FIG. 7A shows exemplary pre-existing credit reports that correspond to the entities, events and entries of FIG. 7. Credit report 751 relates to the Business, and includes entries E701, E703, E705 and E707. Credit report 753 relates to Owner 1, and includes entries E709, E711, and E713. Credit report 755 relates to Owner 2, and includes entries E715, E717, and E719. Credit report 757 relates to Owner 3, and includes entries E721, E723 and E725.

FIG. 8 shows exemplary composite credit reports according to an aspect of the present invention. Composite credit reports 801, 803, 805 and 807 are each formed with one or more entries from multiple of the entities in FIGS. 7 and 7A. In forming composite credit reports according to this aspect of the present invention, different rule sets or criteria can be employed to determine which entries are included. Composite credit reports 801, 803, 805 and 807 each utilize simple exemplary criteria for purposes of illustration.

In particular, exemplary composite credit report 801 includes each entry related to the Business, and so includes entries E701, E703, E705 and E707. Composite credit report 801 further includes entries from Owners that meet a certain threshold of “importance” or size, and so therefore includes entry E709 (related to a mortgage of Owner 1) and E715 (related to a mortgage of Owner 2). It is understood that any such threshold of “importance” or size of account can be established as is useful or desired.

Exemplary composite credit report 803 also includes each entry related to the Business, and so includes entries E701, E703, E705 and E707. Composite credit report 803 further includes negative entries from any Owners. It thus includes entry E715 (a mortgage of Owner 2 showing late payments), entry E717 (a checking account of Owner 2 that was overdrawn), entry E723 (a checking account of Owner 3 that was overdrawn) and entry E725 (a credit card of Owner 3 with late payments). It is understood that any useful or desired standard of a “negative” item may be utilized with the invention.

Exemplary composite credit report 805 addresses a situation where a particular ancillary entity may be considered more important or relevant than other ancillary entities. In this example, information related to Owner 1 is assumed to be more important or relevant, for example because Owner 1 is a majority owner, the primary manager, or the like. Specifically, exemplary composite credit report 805 includes each entry related to the Business, and so includes entries E701, E703, E705 and E707. Composite credit report 805 further includes each entry from pre-existing credit report 753 related to Owner 1, and so includes entries E709, E711 and E713. By way of further example, composite credit report 805 further includes negative entries from any Owners. It thus includes entry E715 (a mortgage of Owner 2 showing late payments), entry E717 (a checking account of Owner 2 that was overdrawn), entry E723 (a checking account of Owner 3 that was overdrawn) and entry E725 (a credit card of Owner 3 with late payments).

It is understood that various criteria such as importance of entry, negative items, items specific to an ancillary entity, etc may be included as useful or desired, and may be used in any combination as useful or desired. As a further example, exemplary composite credit report 807 includes entries for the Business that meet an “importance” threshold (entry E701), plus negative entries for the Business (entry E703), plus entries for Owners 1, 2 and 3 that meet the same or separate “importance” threshold (entries E709 and E715), plus any additional negative entries for Owners 1, 2 and 3 (entries E717, E723 and E725).

In a further preferred embodiment of the invention, a neural network or other form of machine learning process is utilized to make selections of which entries to include from credit reports related to different entities. Examples of such neural networks and other machine learning processes, as well as exemplary training techniques and data, are set forth herein.

As noted above, in the examples of FIGS. 7, 7A and 8, it is assumed that the credit entries accurately reflect the corresponding event. In reality, this will not always happen. Instead, as with the examples of FIGS. 1-6 above, individual credit report entries may reflect errors or omissions, and common events from separate credit reports may reflect inconsistent information. Accordingly, a further exemplary embodiment of the invention utilizes a combination of the above embodiments and features to form a composite credit report according to the present invention. For example, a composite credit report according to the present invention can be created using pre-existing credit reports related to more than one entity, as set forth in FIGS. 7, 7A, and 8. In addition, for at least one of the entities, more than one credit report may be utilized, as exemplified with respect to a single entity in FIGS. 4 through 6. In this manner, a system according to the invention can utilize any of the general aspects described herein in conjunction with other aspects.

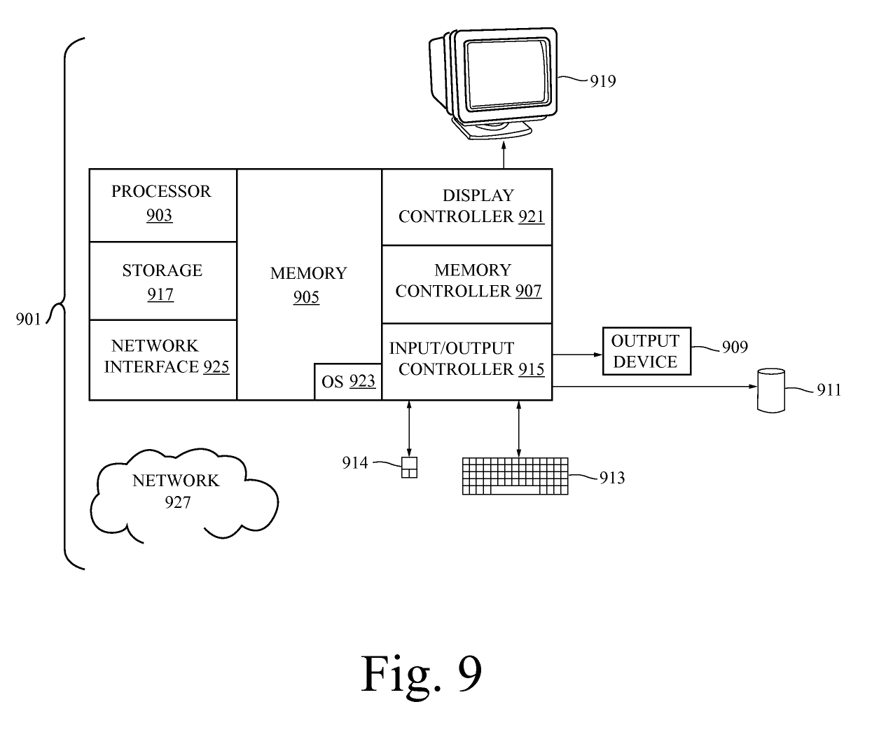

FIG. 9 shows an exemplary computer hardware system that may be utilized according to the present invention. In embodiments that do not involve neural networks or other forms of machine learning, any useful computer hardware, for example 901, may be utilized. In an exemplary embodiment computer 901 includes a processor 903, memory 905 coupled to a memory controller 907, and one or more input and/or output (I/O) devices 909, 911, 913 and/or 914 (or peripherals) that are communicatively coupled via a local input/output controller 915. The input/output controller 915 can be, for example but not limited to, one or more buses or other wired or wireless connections, as is known in the art. The input/output controller 915 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 903 may be a hardware device for executing software, particularly that stored in memory 905. The processor 903 can be any custom, made or commercially available processor, a central processing unit (CPU), an auxiliary processor among several processors associated with the computer 901, a semiconductor based microprocessor (in the form of a microchip or chip set), a macroprocessor, or generally any device for executing software instructions.

The memory 905 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 905 may incorporate electronic, magnetic, optical, and/or other types of storage media. Note that the computer 901, or particular elements of computer 901 can have a distributed architecture, where various components are situated remote from one another, but can be accessed by the processor 903.

The software in memory 905 may include one or more separate programs, each of which comprises an ordered listing of executable instructions for implementing logical functions. In the example of FIG. 9, the software in the memory 905 includes the code for executing the methods and features described herein in accordance with exemplary embodiments, and a suitable operating system (OS) 923. The operating system 923 essentially controls the execution of other computer programs, such the evaluation systems and methods described herein, and provides scheduling, input-output control, file and data management, memory management, and communication control and related services. Computer 901 may have additional components such as display 919, display controller 921, and network interface 925 for connection to network 927.

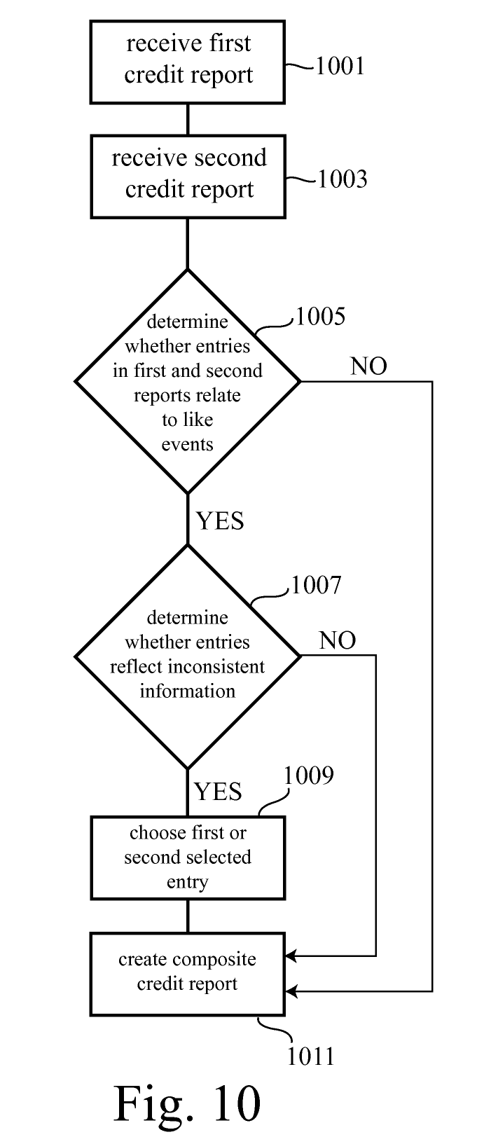

FIGS. 10 through 15 show various exemplary methods according to the present invention. It should be understood that, generally, for each of the exemplary methods shown in the Figures and, the order of steps may vary from that shown. In the same manner, the order of steps recited in any claim below may also vary as desired or useful. Moreover, in each exemplary method of the Figures certain steps may be omitted as desired, or additional steps included. Such variance is understood to be within the scope of the invention. Likewise, various aspects of the invention shown in any of the Figures may be optionally combined with aspects shown in one or more other Figures. The exemplary description and Figures set forth herein provide some examples of such variation, combination, substitution and/or omission, but it is understood that any other useful or desired combination of such features is within the scope of the invention.

FIG. 10 shows an exemplary method of forming a composite credit report according to the present invention. In step 1001, a first credit report is received. It is understood that in the term “first” credit report herein is used for clarity and convenience of description, and is not considered limiting. It is also understood that the term “received” is construed broadly, to include any receipt of information, including the retrieval of or access to information already in the possession of the potential creditor (for example proprietary information as described above). The term “credit report” is likewise understood broadly, as set forth above. In step 1003, a second credit report is received. It is understood that in the term “second” credit report herein is used for clarity and convenience of description, and is not considered limiting. For purposes of the example of FIG. 10, it is assumed that the first credit report and the second credit report relate to the same entity.

In step 1005, it is determined whether entries in the first and second credit reports relate to like events. As set forth above, this determination can take place in any useful or desired manner, for example using sorting and/or comparison software as known by one of ordinary skill in the art. In the example of FIG. 10, there may be a single pair of entries in the first and second credit reports that relate to a single like events; or there may be multiple pairs of entries in the first and second credit reports that relate to like events, respectively. If an entry in either the first or second credit report does not relate to like events (the “NO” result in the determination), then that entry may be included within a composite credit report as shown in step 1011.

It is understood from FIG. 10 that steps may also overlap with one another. As one example, step 1011 of creating a composite credit report may begin after any determination is made for any entry pursuant to step 1005, and then may take place continuously or periodically as other steps of the exemplary method are performed, or as steps are repeated for other entries of the first and/or second credit reports. In the same manner, other steps in the example of FIG. 10, steps of any other example of the Figures, and/or steps in any other embodiment of the invention may overlap with one another as useful or desired.

In step 1007 of FIG. 10, for each pair of entries that relate to like events, it is determined whether the entries reflect inconsistent information. If not, then preferably one instance of the event may be included within composite credit report as shown in step 1011. If the two entries reflect inconsistent information, then in step 1009 one or the other of the selected entries is preferably included in composite credit report according to step 1011. Such a selection may take place according to any useful or desired method or criteria, as set forth above. In a preferred embodiment, it is performed utilizing a neural network or other machine learning process or mechanism, as described above.

In step 1011, a composite credit report is created. This may include selections from among common entries reflecting inconsistent information, as well as any other entries or combination of entries from the first and second credit reports. It is understood that this step may take place over time, as set forth above. It is also understood that the word “create” as used herein with this and other examples is construed broadly, to include any formation or association of entries.

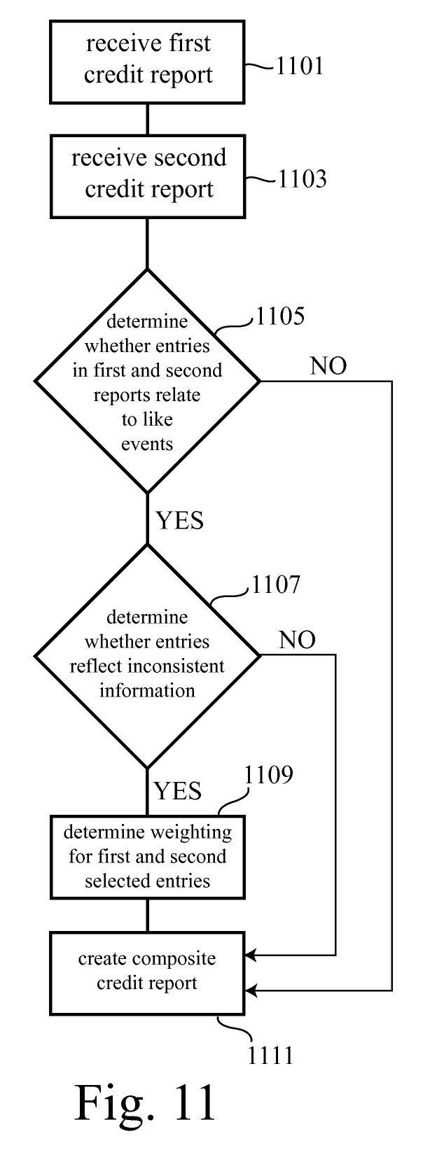

FIG. 11 shows another exemplary method according to the present invention. The example of FIG. 11 is similar to that of FIG. 10, with one identified exception as set forth below. In steps 1101 and 1102, a first credit report and a second credit report are received, with each of the descriptive terms understood broadly as set forth above. For purposes of the example of FIG. 11, it is assumed that the first credit report and the second credit report relate to the same entity.

In step 1105, it is determined whether entries in the first and second credit reports relate to like events. As set forth above, this determination can take place in any useful or desired manner, for example using sorting and/or comparison software as known by one of ordinary skill in the art. In the example of FIG. 11, there may be a single pair of entries in the first and second credit reports that relate to a single like events; or there may be multiple pairs of entries in the first and second credit reports that relate to like events, respectively. If an entry in either the first or second credit report does not relate to like events (the “NO” result in the determination), then that entry may be included within a composite credit report as shown in step 1111, as described above with respect to the example of FIG. 10.

In step 1107 of FIG. 11, for each pair of entries that relate to like events, it is determined whether the entries reflect inconsistent information. If not, then preferably one instance of the event may be included within composite credit report as shown in step 1111.

Step 1109 of FIG. 11 differs from the example of FIG. 10. Specifically, where two entries relate to like events and contain inconsistent information, instead of selecting preferably one or the other (as in FIG. 10), a weighting for each of the two entries (again referred to as “selected entries” in the Figure) is made. This weighting can be done in any useful or desirable manner, as described above. In a preferred embodiment, it is performed utilizing a neural network or other machine learning process or mechanism, as described above.

In step 1111, a composite credit report is created. This may include weighted entries from among common entries reflecting inconsistent information, as well as any other entries or combination of entries from the first and second credit reports. It is understood that this step may take place over time, as set forth above.

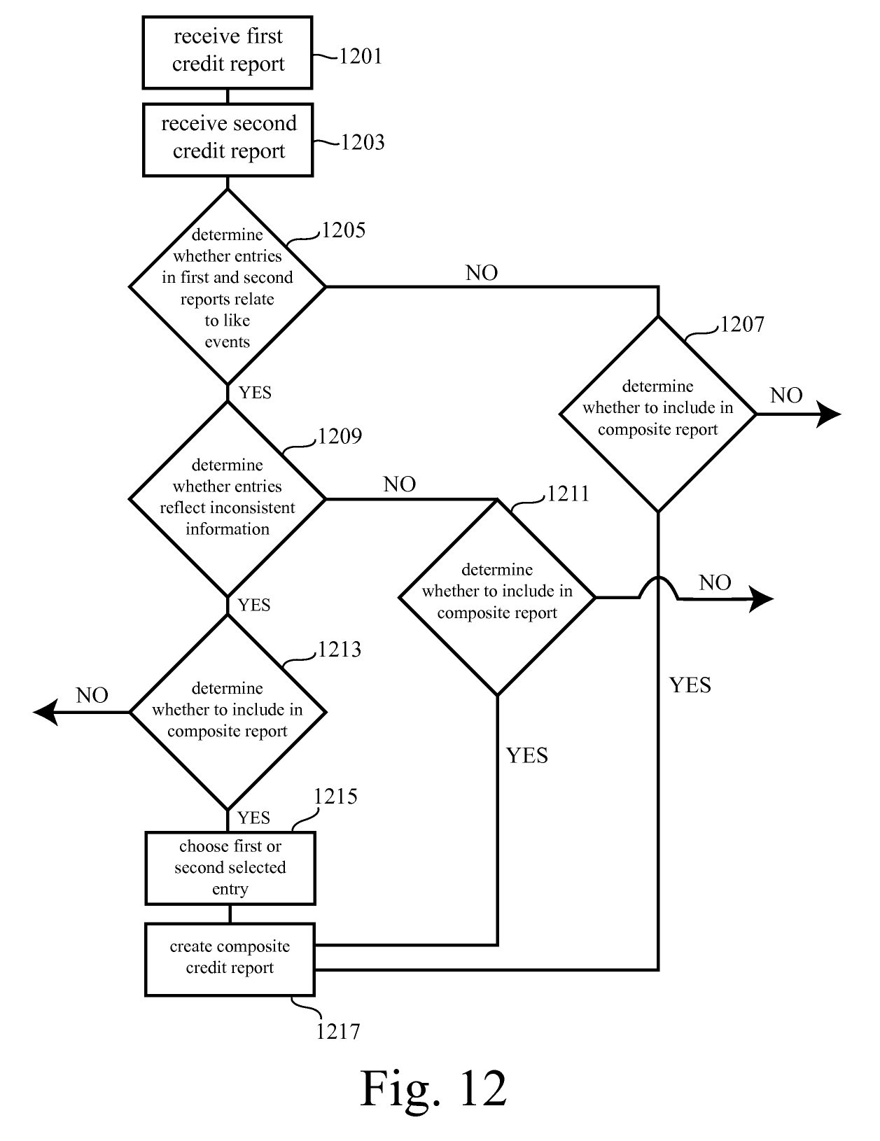

FIG. 12 shows another exemplary method according to the present invention. In particular, FIG. 12 shows steps in which decisions of whether or not to include entries in a composite credit report are made. It is understood that such decisions may be implicit or included in other examples and embodiments, even if not shown in the Figures.

In steps 1201 and 1202, a first credit report and a second credit report are received, with each of the descriptive terms understood broadly as set forth above. For purposes of the example of FIG. 12, it is assumed that the first credit report and the second credit report relate to the same entity.

In step 1205, it is determined whether entries in the first and second credit reports relate to like events. As set forth above, this determination can take place in any useful or desired manner, for example using sorting and/or comparison software as known by one of ordinary skill in the art. In the example of FIG. 12, there may be a single pair of entries in the first and second credit reports that relate to a single like events; or there may be multiple pairs of entries in the first and second credit reports that relate to like events, respectively. If an entry in either the first or second credit report does not relate to like events (the “NO” result in the determination), then in step 1207 a determination is made of whether to include that entry within a composite credit report. That determination may be made in any useful manner, for example utilizing neural networks and/or other machine learning processes as set forth above. If yes, then that entry may be included within a composite credit report as shown in step 1217, as generally described above with respect to the example of FIG. 10.

In step 1209 of FIG. 12, for each pair of entries that relate to like events, it is determined whether the entries reflect inconsistent information. If not, then in step 1211 a determination is made of whether to include that entry within a composite credit report. If yes, then preferably one instance of the event may be included within composite credit report as shown in step 1217.

If a given pair of common entries does reflect inconsistent information, then in step 1213 it is determined whether to include or not include either of the entries in a composite credit report (or in an alternative embodiment, whether to included weighted entries). If so, then a determination of which entry to include is made in step 1215. Preferably, one or the other of the selected entries is included in composite credit report. Such a selection may take place according to any useful or desired method or criteria, as set forth above. In a preferred embodiment, it is performed utilizing a neural network or other machine learning process or mechanism, as described above. It is noted that step 1215 may occur after step 1213, or the two may be performed in conjunction with one another.

In an alternative embodiment not shown, weights may be determined for each of the common entries. This weighting step, an alternative to step 1215 in FIG. 12, can be done in any useful or desirable manner, as described above. In a preferred embodiment, it is performed utilizing a neural network or other machine learning process or mechanism, as described above. In conjunction with that step, or before or after, a determination can be made according to step 1213, to decide whether to include such entries in a composite credit report.

In step 1217, a composite credit report is created. This may include weighted entries from among common entries reflecting inconsistent information, as well as any other entries or combination of entries from the first and second credit reports. It is understood that this step may take place over time, as set forth above.

It is understood that decisions regarding whether to include entries in a composite credit report can take place in an order different than shown in FIG. 12 (and other Figures herein). For example, entries in the first and/or second credit reports can be evaluated after receipt, before step 1205, to determine if one or more of the entries should be included in a composite credit report. It is understood that such variants in step order may be made as useful or desired, and are within the scope of the invention.

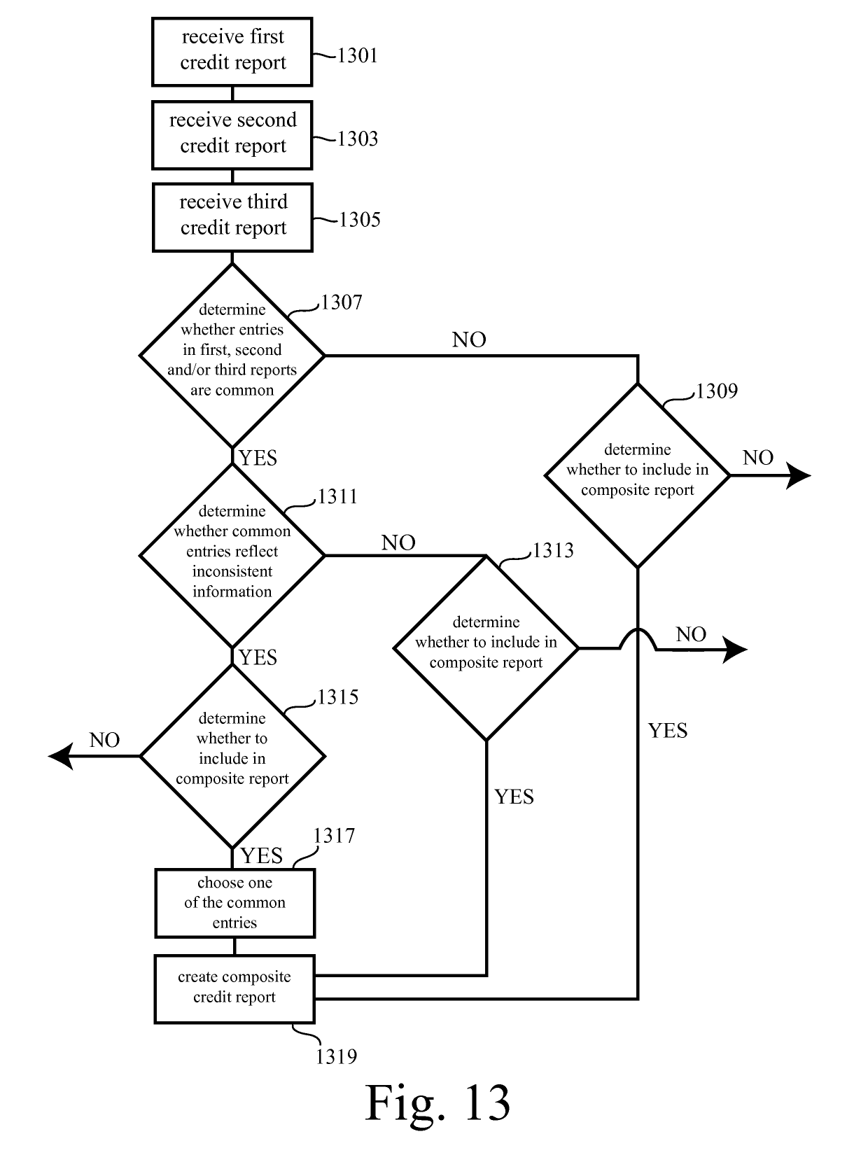

FIG. 13 shows another exemplary method according to the present invention. In FIG. 13, more than two credit reports are utilized to form a composite credit report. In the exemplary embodiment of FIG. 13, three reports are utilized, but it is understood that additional reports may be utilized using the same principles.

In steps 1301, 1302, and 1303, first credit report, a second credit report, and a third credit report are received, respectively. Each of the descriptive terms already identified previously is understood broadly, as set forth above. Likewise, it is understood that in the term “third” credit report herein is used for clarity and convenience of description, and is not considered limiting. For purposes of the example of FIG. 13, it is assumed that the first credit report, the second credit report, and the third credit report relate to the same entity.

In step 1307, it is determined whether any entries in the first, second and/or third credit reports relate to like events, i.e., are common entries with another entry. It is understood that in this embodiment entries can be common to all three credit reports (or greater number as utilized), or can be common to a subset of the credit reports. As set forth above, this determination can take place in any useful or desired manner, for example using sorting and/or comparison software as known by one of ordinary skill in the art. In the example of FIG. 13, there may be a single group of entries in the first, second and third credit reports that relate to a single like event; or there may be multiple groups or pairs of entries that relate to like events, respectively. If an entry in any of the first, second or third credit report is not common with any other entry (the “NO” result in the determination), then in step 1309 a determination is made of whether to include that entry within a composite credit report. If yes, then that entry may be included within a composite credit report as shown in step 1319, as generally described above with respect to the example of FIG. 10.

In step 1311 of FIG. 13, for each group or pair of common entries, it is determined whether the entries reflect inconsistent information. If not, then in step 1313 a determination is made of whether to include that entry within a composite credit report. If yes, then preferably one instance of the event may be included within composite credit report as shown in step 1319.

If a given group or pair of common entries does reflect inconsistent information, then in step 1315 it is determined whether to include or not include any of the entries in a composite credit report (or in an alternative embodiment, whether to included weighted entries). If so, then a determination of which entry to include is made in step 1317. Preferably, one of the group of selected entries is included in composite credit report. Such a selection may take place according to any useful or desired method or criteria, as set forth above. In a preferred embodiment, it is performed utilizing a neural network or other machine learning process or mechanism, as described above. It is noted that step 1315 may occur after step 1317, or the two may be performed in conjunction with one another.

In an alternative embodiment not shown, weights may be determined for each of the common entries. This weighting step, an alternative to step 1317 in FIG. 13, can be done in any useful or desirable manner, as described above. In a preferred embodiment, it is performed utilizing a neural network or other machine learning process or mechanism, as described above. In conjunction with that step, or before or after, a determination can be made according to step 1315, to decide whether to include such entries in a composite credit report.

In step 1319, a composite credit report is created. This may include weighted entries from among common entries reflecting inconsistent information, as well as any other entries or a combination of entries from the first, second and third credit reports. It is understood that this step may take place over time, as set forth above.

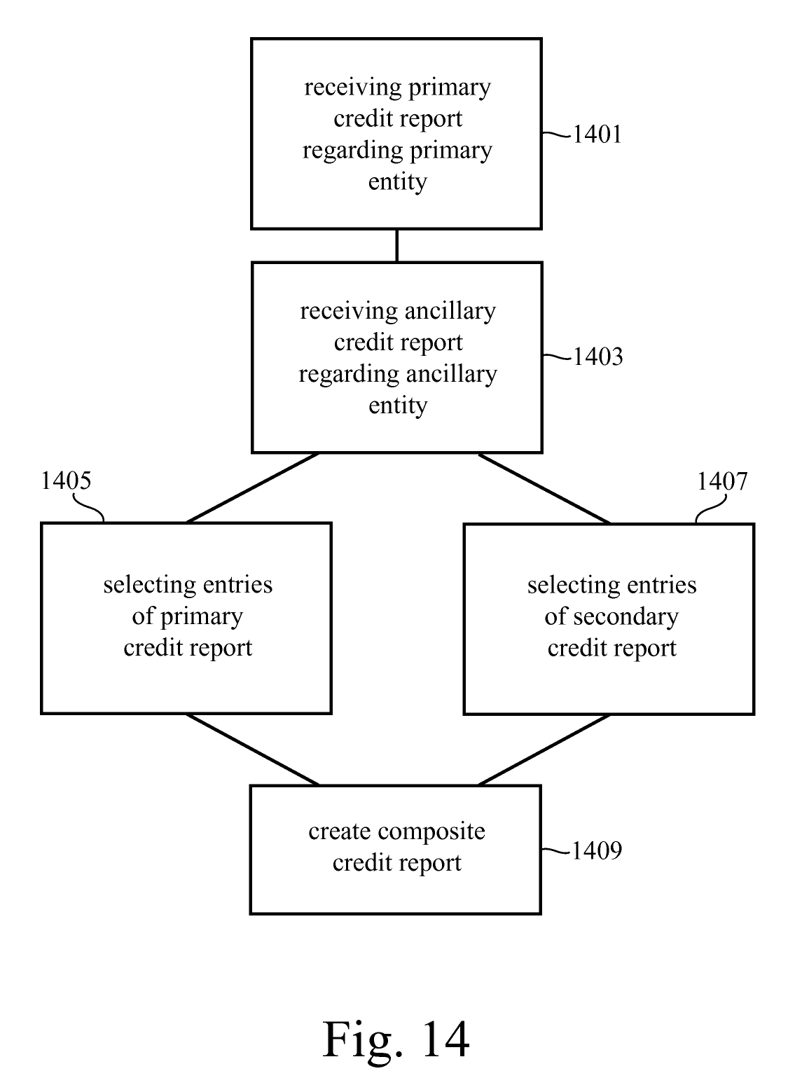

FIG. 14 shows another exemplary method according to the present invention. FIG. 14 illustrates an embodiment in which credit reports for two separate entities are utilized to create a composite credit report. In step 1401, a primary credit report regarding a primary entity is received. In step 1403, an ancillary credit report regarding an ancillary entity is received. The terms “primary” and “ancillary” are construed without limitation, as set forth above.

In step 1405, entries of the primary credit report are selected for inclusion in a composite credit report. Such a selection may take place according to any useful or desired method or criteria, as set forth above. In a preferred embodiment, it is performed utilizing a neural network or other machine learning process or mechanism, as described above. In step, 1407 entries of the ancillary credit report are selected for inclusion in the composite credit report. Such a selection may take also place according to any useful or desired method or criteria, as set forth above. In a preferred embodiment, it is performed utilizing a neural network or other machine learning process or mechanism, as described above.

It is understood that steps 1405 and 1407 may take place in any order, or that the steps may overlap. It is also understood that the selections may be interrelated, so that the selection entries from the primary credit report affects the selection of entries from the ancillary credit report, and/or vice versa.

In step 1409, a composite credit report is created from the selected entries; the term “created” being construed broadly as set forth above. While FIG. 14 illustrates an example utilizing credit reports related to two entities, it is understood that the principles of the invention may be applied to systems and methods utilizing credit reports related to three or more entities. Also, while FIG. 14 illustrates an example with a single credit report related to each entity, it is understood that multiple credit reports may be utilized for one or more of the entities.

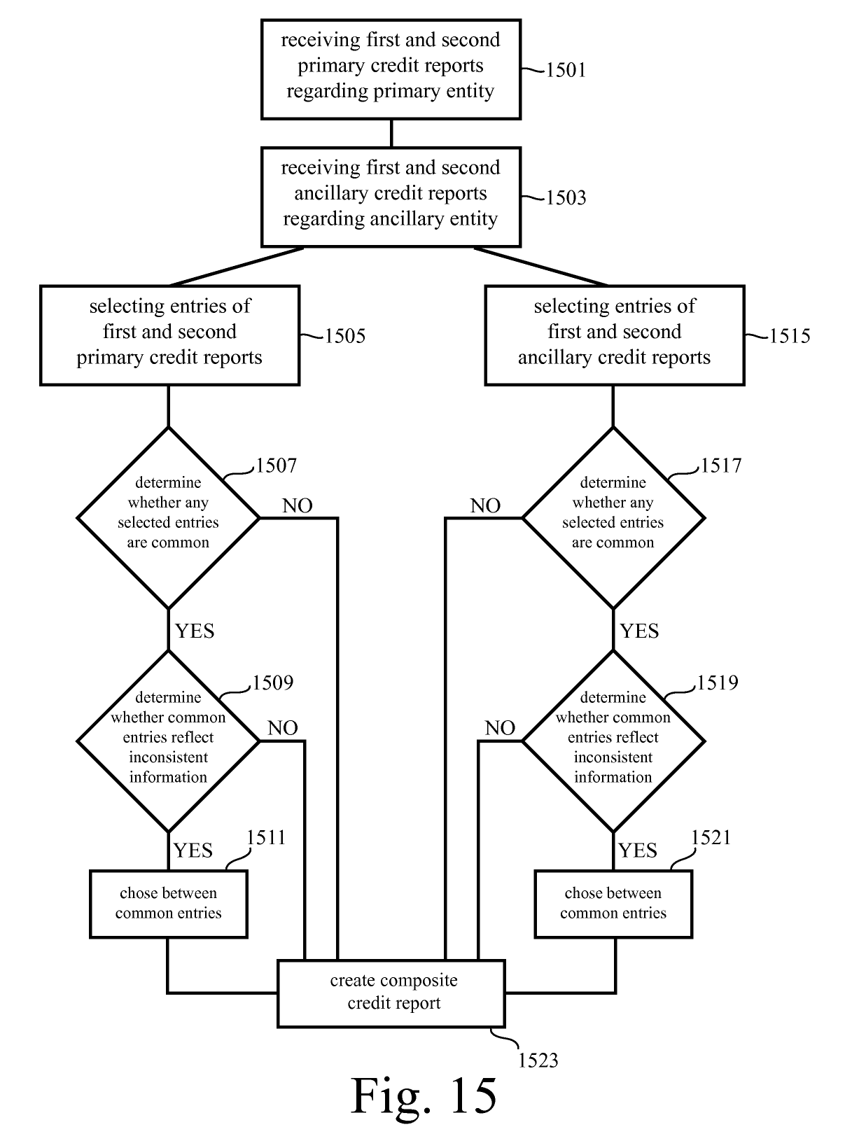

FIG. 15 illustrates another exemplary method according to the present invention. In the example of FIG. 15, multiple credit reports for each entity are utilized. In step 1501 of FIG. 15, first and second credit primary credit reports are received regarding a primary entity. In step 1503, first and second ancillary credit reports re received regarding an ancillary entity.

In step 1505, entries for the first and second primary credit reports are selected. In step 1507, it is determined wither any of the selected entries of the primary credit reports are common; that is, relate to the same event. In step 1509, it is determined whether any common entries of the primary credit reports reflect inconsistent information. In step 1511, where common entries reflect inconsistent information, preferably one of the common entries is selected (or the entries are weighted as describe in alternative embodiments above). It is understood that steps 1505, 1507, 1509 and 1511 may be performed in any order that is useful or desired. It is further understood that these selections and determinations may be performed in any useful manner, for example as described above. Entries that are not common or that reflect consistent information may be included in a composite credit report, as desired.

In step 1515, entries for the first and second ancillary credit reports are selected. In step 1517, it is determined wither any of the selected entries of the ancillary credit reports are common; that is, relate to the same event. In step 1519, it is determined whether any common entries of the ancillary credit reports reflect inconsistent information. In step 1521, where common entries reflect inconsistent information, preferably one of the common entries is selected (or the entries are weighted as describe in alternative embodiments above). It is understood that steps 1515, 1517, 1519 and 1521 may be performed in any order that is useful or desired. It is further understood that these selections and determinations may be performed in any useful manner, for example as described above. Entries that are not common or that reflect consistent information may be included in a composite credit report, as desired.

In step 1523, a composite credit report is created, as described in various embodiments above.

It is understood that while FIG. 15 shows two entities and two credit reports for each entity, the inventive method may utilize credit reports related to three or more entities, along with multiple credit reports for one or more of the entities.

It should be noted that the above-mentioned embodiments illustrate rather than limit the invention, and that those skilled in the art will be able to design many alternative embodiments without departing from the scope of the appended claims. Use of the term “comprise” or “comprising” and their conjugations does not exclude the presence of elements or steps other than those stated in a claim. The article “a” or “an” preceding an element does not exclude the presence of a plurality of such elements. As further described above, the invention may be implemented by means of hardware comprising several distinct elements, and those elements may be co-located or distributed. The fact that certain measures are recited in mutually different dependent claims does not indicate that a combination of these measures cannot be used to advantage. All such variants apparent to one of ordinary skill in the art based on the above disclosures should be considered within the scope of the invention.

What is claimed is:

1. A method of evaluating credit, comprising:
receiving a first credit report regarding an entity from a first reporting agency, the first credit report containing at least one first entry;
receiving a second credit report regarding the entity from a second reporting agency, the second credit report containing at least one second entry;
determining whether a selected first entry and a selected second entry relate to a same event;
determining, when the selected first entry and the selected second entry relate to the same event, whether the selected first entry and the selected second entry reflect inconsistent information regarding the same event; and
creating a composite credit report containing at least one of the selected first entry and the selected second entry.

2. The method according to claim 1, wherein creating a composite credit report comprises including the selected first entry or the selected second entry, but not both.

3. The method according to claim 1, wherein creating a composite credit report comprises applying a first weight to the selected first entry and applying a second weight to the selected second entry.

4. The method according to claim 1, wherein the composite credit report is created utilizing a neural network.

5. The method according to claim 1, further comprising:
receiving at least one additional credit report, with additional respective entries;
determining whether a the selected first entry, the selected second entry, and a selected third entry of the at least one additional credit report relate to the same event;
determining, when the selected first entry, the selected second entry and the selected their entry relate to the same event, whether any of the selected first entry, the selected second entry and the selected third entry reflect inconsistent information regarding the same event; and
creating a composite credit report containing at least one of the selected first entry, the selected second entry, and the selected third entry.

6. The method according to claim 5, wherein creating a composite credit report comprises including only one of the selected first entry, the selected second entry, and the selected third entry.

7. The method according to claim 5, wherein creating a composite credit report comprises applying weights to the selected first entry, the selected second entry, and the selected third entry.

8. The method according to claim 5, wherein the composite credit report is created utilizing a neural network.

9. A method of evaluating credit, comprising:
receiving a first credit report regarding an entity from a first reporting agency, the first credit report containing at least one first entry;
receiving a second credit report regarding the entity from a second reporting agency, the second credit report containing at least one second entry;
determining whether a selected first entry and a selected second entry are common entries;
determining whether the selected first entry and selected second entry reflect inconsistent information; and
if the selected first entry and the selected second entry are common entries that reflect inconsistent information, creating a composite credit report that includes at least one of the selected first entry and the selected second entry.

10. The method according to claim 9, wherein creating a composite credit report comprises including the selected first entry or the selected second entry, but not both.

11. The method according to claim 9, wherein creating a composite credit report comprises applying a first weight to the selected first entry and applying a second weight to the selected second entry.

12. The method according to claim 9, wherein the composite credit report is created utilizing a neural network.

13. A method of evaluating credit, comprising:
receiving a primary credit report regarding a primary entity, the primary credit report containing at least one primary entry;
receiving an ancillary credit report regarding an ancillary entity, the ancillary credit report containing at least one ancillary entry; and
creating a composite credit report that includes at least one of the primary entries and at least one of the ancillary entries.

14. The method according to claim 13, wherein the composite credit report is created utilizing a neural network.

15. The method according to claim 13, wherein the primary credit report includes a plurality of primary entries, the ancillary credit report includes a plurality of ancillary entries, and wherein the composite credit report includes at least two primary entries and at least two ancillary entries.

16. A method of evaluating credit, comprising:
receiving a first credit report regarding a primary entity, the first credit report containing at least one first primary entry;
receiving a second credit report regarding the primary entity, the second credit report containing at least one second primary entry;
receiving an ancillary credit report regarding an ancillary entity, the ancillary credit report containing at least one ancillary entry; and
creating a composite credit report that includes at least one of the first primary entries and the second primary entries, and at least one of the ancillary entries.

17. The method according to claim 16, wherein creating a composite credit report comprises including the at least one first primary entry or at least one second primary entry, but not both.

18. The method according to claim 16, wherein creating a composite credit report comprises applying a first weight to a first primary entry and applying a second weight to a second primary entry.

19. The method according to claim 16, wherein the composite credit report is created utilizing a neural network.

20. The method according to claim 19, wherein creating a composite credit report comprises including the at least one first primary entry or at least one second primary entry, but not both.
